(19) United States
(12) Patent Application Publication
(10) Pub. No.: US 2014/0324808 A1
(43) Pub. Date: Oct. 30, 2014

(54) Semantic Segmentation and Tagging and Advanced User Interface to Improve Patent Search and Analysis

(71) Applicants: Sumeet Sandhu, Santa Clara, CA (US); Anurag Bist, Newport Beach, CA (US)

(72) Inventors: Sumeet Sandhu, Santa Clara, CA (US); Anurag Bist, Newport Beach, CA (US)

(21) Appl. No.: 14/217,145

(22) Filed: Mar. 17, 2014

Related U.S. Application Data
(60) Provisional application No. 61/801,594, filed on Mar. 15, 2013.

(51) Int. Cl. G06F 17/30; G06F 17/28; G06F 17/27; G06F 17/21; G06F 17/24

(52) U.S. Cl. CPC G06F 17/30864; G06F 17/211; G06F 17/24; G06F 17/2785; G06F 17/28
USPC 707/706; 715/201; 715/256

(57) ABSTRACT

A new method for semantic segmentation and tagging of a patent or a technical document is provided. The semantic tags are used for search and display of patents. The semantic tagging method involves creating automatic tags for preamble, elements, and sub-elements, and their respective attributes and relationships in patent claims. The tags are used in patent search to improve search performance. The tags are used in a novel user interface for viewing and analyzing one or more patents. The user interface provides a unique method to display different tags of a patent, which provides critical information towards comprehending the patent, and helps create better search queries related to the patent.

### CROSS-REFERENCE TO RELATED APPLICATIONS

This application claims benefit to U.S. Provisional Patent Application No. 61/801,594, filed Mar. 15, 2013, the disclosure of which is incorporated by reference in its entirety.

### FIELD OF THE INVENTION

The present invention relates to data mining using natural language processing and interactive user annotations, and more particularly to methods for viewing and searching a database of patents or other documents using tags based on semantic segmentation.

### BACKGROUND

Despite advances in computing and search technology, legal discovery in intellectual property transactions continues to cost billions of dollars worldwide. For instance, take the example of the patent process—each phase in the patent process requires search and discovery by different parties, repeatedly. Each stakeholder such as the patent applicant, prosecuting attorney and examiner before grant, litigating attorney, defending attorney and licensing attorney after grant, performs their own due diligence and analysis—independently. The number of patent search and analysis tools available is almost as complex and assorted as the parties involved in post-grant transactions such as search experts, technology experts, lawyers and judges.

Patents are highly structured documents, and unlike broad internet search, they ought to be relatively easy to index and search. There are less than 100 million total patents worldwide—a small number by internet standards. Patents have well defined fields such as Title, Abstract, Claims and Specification (Description, Drawings, and References). The crux of the invention claimed by a patent is described in the Claims that are usually written in a prescribed format and style. The independent claims capture the core inventive steps, and the dependent claims describe extensions of the idea (which are additional constraints or ‘limitations’ on the independent claim in a legal sense). However, what makes the patent search hard is that despite the prescribed structure there are many ways to say the same thing. In order of increasing scope: a single word may have many synonyms, similar phrases, or technical equivalents; a set of claims may split ideas across independent and dependent claims in many ways; a patent may split content across claims, description, drawings and references in many ways; similar patents may have subtle differences in legal language for broader scope or patentability; patent classes may have high overlap or non-uniform coverage of technical areas; and finally the inventor's perspective impacts the focus of the invention as “one man's trash is another man's treasure”.

Patent search today is largely conducted via non-semantic keyword based search engines. This requires extensive experimentation with keywords and synonyms, Boolean and proximity operators, and multiple patent fields such as classes, title, abstract, claims, forward and backward citations, inventors, assignees, etc. It is a laborious process that requires a large amount of manual intervention and non-deterministic, iterative heuristics to achieve the right context. Patent search is a daunting prospect to the average inventor, to the extent that there is a multi-billion dollar industry engaged in services and tools for search and analysis of patents and broader Intellectual Property. There is a plethora of patent search engines in the market ranging from Government Patent Office Tools to commercial software packages and cloud services, to Google Patents. Each database has its own user interface, format, capabilities, performance, and portability of results.

As is well known in the search community, simple keywords do not capture the semantic context of search. While keyword search casts a wide net for potentially relevant patents (high ‘recall’), it has fairly poor ‘precision’—returning orders of magnitude more results than are relevant, depending on the length of search query and query words. In legal domains such as patent search, it is indeed important to have highest possible recall and not miss a potential patent match that could swing the pendulum in a billion-dollar freedom to operate, infringement, or invalidity trial. However, the poor precision of today's search engines vastly overloads the search and discovery process, slowing it down by orders of magnitude.

The present invention provides a semantic-segmentation based model of patent representation that enables more precise search, and also leads to a visually engaging user interface that accelerates user comprehension, among other things.

### BRIEF SUMMARY OF THE INVENTION

In a first aspect, a method for semantic tagging of a patent claim is provided, the method comprising: semantically analyzing and segmenting the patent claims to create tags for preambles, elements, sub-elements, and their respective attributes; identifying the type of claim, and segmenting the claim into a plurality of tags using Natural Language Processing based algorithms; editing default natural language based segments and tags into more precise or other invention specific segments by means of human curation; creating a flexible dictionary for each tagged segment that pulls in content from patent specification and images and external sources such as technical taxonomies.

In a second aspect, a method for searching for patents similar to the patent of interest by means of queries automatically generated with the semantic segments is provided. The method comprises: analyzing the user's query patent and creating a plurality of semantic tags by segmenting the claims of the user's query patent using natural language processing based algorithm; representing the patent documents on the basis of semantic-segmentation model; parsing the semantic tags to add synonyms, technical taxonomies, adding sub-field tags to identify relationship between the semantic tagged elements; indexing the user's query by mapping the semantic tags with the patent database to derive a result set; and ranking the relevancy score of result set based on semantic tag matching algorithm.

In a third aspect, a web-based user interface for systematically representing a patent claim or a concept that the user is interested in analyzing is provided. The user interface displays the patent claims or the concept into a plurality of semantic tags, wherein the plurality of semantic tags by segmenting the patent claim or concept using natural language processing based algorithm; the said user interface allows the user to edit, annotate, correct the plurality of semantic tags or add comments. The user interface further provides a dictionary feature that allows the user to see synonyms or taxonomies of selected text. The user interface allows the user to select the semantic tags to view the text from the specification and the figures where the selected semantic text is present. The segmentation and annotation provided in the above steps could be used for multiple purposes including, but not limited to: (a) better understanding of a given patent and annotating it for future use or for sharing among different users for patent prosecution, litigation, licensing, assertion, or other uses, (b) tagging the patent with new searchable semantic tags for improving the performance of the patent search engine, and (c) creating better search queries to search for similar patents.

### BRIEF DESCRIPTION OF THE DRAWINGS

Further objects, features and advantages of the present invention will become apparent from the following detailed description taken in conjunction with the accompanying figures showing illustrative embodiments, results and/or features of the exemplary embodiments of the present invention, in which:

FIG. 1 shows a simplified view of how a patent claim describes an invention.

FIG. 2 illustrates the process used by a typical search engine based on keyword search for identifying the similar patent.

FIG. 3 shows a flow chart that describes a process to classify independent claim of a patent into a method claim, system claim or an apparatus claim using Natural Language Processing based algorithm in accordance with an embodiment of the present invention.

FIG. 4 shows a flow chart for identifying Noun Phrases in an independent claim.

FIG. 5 shows a tabular representation of typical Parts of Speech in the English language that are used in the patent document to identify generic Noun Phrases and Preposition phrases.

FIG. 6 represents the grammar used by the Natural Language Processing algorithms to group sequential Part of Speech tags into Noun Phrases, Noun Phrase Elements, Preposition Phrase and Preposition Phrase Elements in accordance with an embodiment of the present invention.

FIG. 7 shows an advanced user interface for systematically representing a patent claim or the concept that the user is interested in analyzing.

FIG. 8 shows user interface of semantic-segmentation based search model displaying color coded claim segments in accordance with an embodiment of the present invention.

FIG. 9 shows a user interface of semantic-segmentation based search model that allows the user to edit the semantic tag claim segments and to add the user's comments, in accordance with an embodiment of the present invention.

FIG. 10 shows a user interface of semantic-segmentation based search model displaying claim segments with active links—a pop up dictionary, in accordance with an embodiment of the present invention.

FIG. 11 shows a user interface of semantic-segmentation based search model displaying claim segments with active links—pop up figures with legend, in accordance with an embodiment of the present invention.

FIG. 12 shows a user interface of semantic-segmentation based search model displaying claim segments with active links—pop up specification references and their referred figures, in accordance with an embodiment of the present invention.

FIG. 13 shows a user interface displaying the result set with relevant score based on semantic tags, in accordance with an embodiment of the present invention.

FIG. 14 shows a user interface displaying “claim worksheet” comparing first independent claim of multiple patents, with color coded claim segments in accordance with an embodiment of the present invention.

FIG. 15 shows a user interface displaying the search history and user metadata saved for retrieval and sharing in accordance with an embodiment of the present invention.

### DETAILED DESCRIPTION OF THE EMBODIMENTS

In the following detailed description of embodiments of the invention, numerous specific details are set forth in order to provide a thorough understanding of the embodiment of the invention. However, it will be obvious to a person skilled in the art that the embodiments of invention may be practiced with or without these specific details. In other instances well known methods, procedures and components have not been described in details so as not to unnecessarily obscure aspects of the embodiments of the invention.

Furthermore, it will be clear that the invention is not limited to these embodiments only. Numerous modifications, changes, variations, substitutions and equivalents will be apparent to those skilled in the art, without parting from the spirit and scope of the invention.

The present invention provides a system and a method for classifying a patent document based on the essential components of the inventions. The method provides a generic way to inter-relate the essential components and associate a relative importance to the essential components. The method accomplish this objective by providing a way to semantically tagging the patent claim or concept using natural language processing based algorithm.

Embodiments of the method of the present invention utilize the fact that the inventions described in the patent documents are conceived around finite concepts. A typical inventor comes up with a new idea based on some existing ideas and concepts, and applies the idea to a system with finite components to extract some benefit. The invention consists of multiple conceptual components or ‘elements’, which may be objects, actions, processes, concepts, equations, reactions, code fragments, applications, etc. The novelty of the invention lies in the constitution of one or more of the elements, or the relationships among elements, or both—as captured in the claims. Embodiments of the present invention provide a method to call out the various assumptions and concepts in a typical invention described in a patent document in a much more explicit manner, such that they can be tagged and individually searched and analyzed. Most importantly, the present invention provides a method where the core invention can be pinpointed and tagged by using key components and their relationships. Embodiments of the invention also provide a method that allows association of estimated economic values and applications to the patent at an element level. The process of tagging all the patents with all possible applications of the invention and their respective economic values can be executed in number of ways such as by crowdsourcing or sole sourcing to one or more of: universities, subject matter experts, patent search firms, education testing services. Several monetization schemes can be designed to use these analytics in different patent centric scenarios—valuation, due diligence, litigation, IP transaction clearinghouse, patent, technology and business strategy, etc—and offered as a range of services from freemium for individual inventors to premium for corporate legal counsels.

The claims are the important constituents of the invention. Apart from defining the scope of protection for the invention, the claims categorically provide an overview of the novel and inventive aspects of the invention. The claims are formulated to define the essential components of the invention and how the essential components are related to each other. The claims are generally of two types: independent claims and the dependent claims. Independent claims stand alone and do not refer to other claims and the dependent claims refer to the independent claims and add limitation to the independent claims. A typical claim consists of a preamble part defining the field of the invention, a transitional phase that characterizes the element that follows and a set of limitations that define the attributes of the invention.

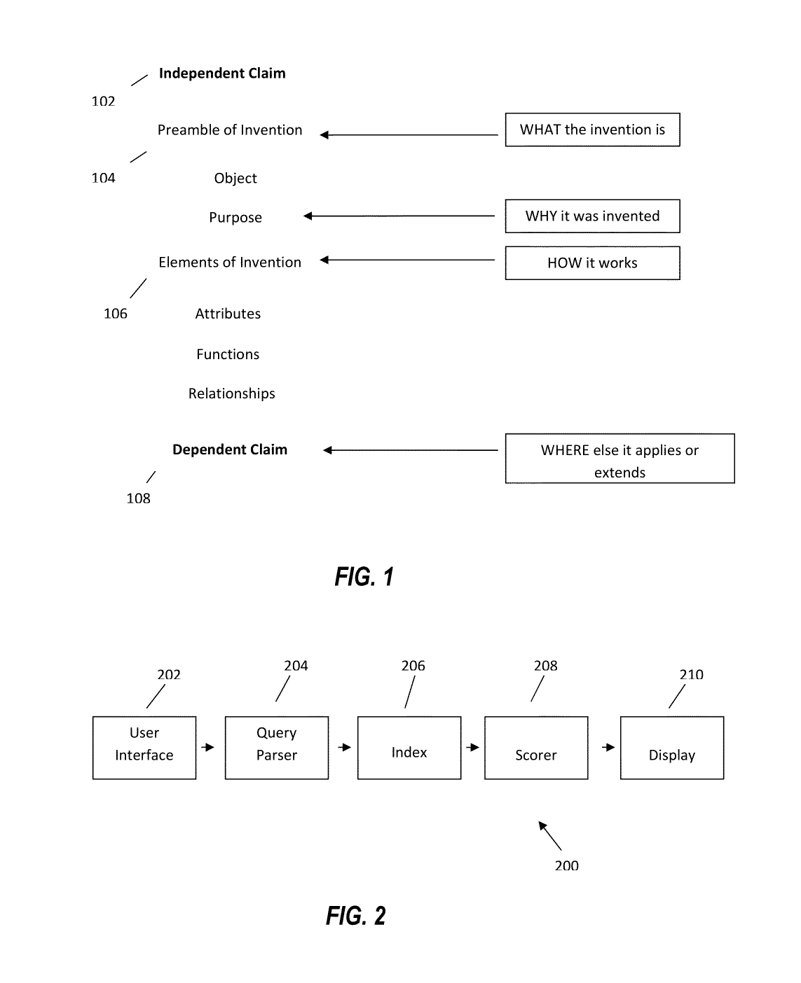

FIG. 1 shows a simplified view of how a patent claim describes an invention. An independent claim 102 usually consists of multiple semantic segments—a preamble 104 and its attributes, invention elements 106 and their attributes, and possibly sub-elements and their respective attributes. The preamble 104 describes WHAT the invention is, and WHY it was invented. The elements 106, sub-elements and attributes (attributes include qualifiers, properties, functions, relationships, etc.) describe HOW the invention works. Independent claims capture the core of the invention. A dependent claim 108 describes WHERE else the invention applies, extends, or is modifiable. Dependent claims add or modify attributes of elements and sub-elements, or introduce new sub-elements and their attributes Important details around terms used in Claims are usually found in the Specification—terms are often defined in the Description and references are made to the Drawings. Higher level abstractions describing the patent are often available in the Title and Abstract.

A patent can therefore be systematically represented by extracting semantic segments from independent and dependent claims—preamble, elements, sub-elements and respective attributes—and supplementing them with semantic segments from the Title, the Abstract and the Specification.

### Tags and Segments

Segmenting and tagging a document generally requires creation of a data structure composed of (1) segment boundaries in the original document characterized by character or word locations or other positional markers of content, (2) segment content in the original document including text, images, or other content, (3) tag labels used to mark the segment as being of a certain tag type, and (4) tag content further characterizing the tag including text, images, links, references, and metadata entered by the user or recorded by the document management system. The tag content may be pulled from elsewhere in the document or from sources external to the document.

For semantic patent tagging proposed in this invention, the tag content may be a dictionary or lookup table, with each tag's dictionary containing terms similar in meaning or connotation to the segment content. The terms may be pulled from taxonomies, ontologies, bibliographies, indices, tables of content, summaries and descriptions of a multitude of sources: databases comprising language and grammar dictionaries and thesauruses, synonyms, homonyms, hypernyms, hyponyms, patent classes, library records, academic publications, scientific and technical publications, professional and business publications, and web glossaries.

Furthermore, the tag's dictionary may contain terms pulled from fields in the patent being tagged, or from fields in other patents. The field may be one or more of: title, abstract, claims, background, field of invention, summary of invention, description of figures, description of embodiments, specification, images, figures, drawings, tables, and references.

The tag contents may also contain a lookup table containing links and references related to the segment content. The links and references may be pulled from fields in the patent being tagged, or from fields in other patents, the fields comprising title, abstract, claims, background, field of invention, summary of invention, description of figures, description of embodiments, specification, images, figures, drawings, tables, and references. The links and references may also be pulled from external sources described above.

Implementation of tagging can be done by means of annotation software built with languages using HTML, CSS, Javascript, JQuery, EmberJS, AngularJS, coffeescript, NodeJS, XML, HTML5, java, C, C+, Csharp, python, Django, Natural Language Toolkit (NLTK) in python, Open NLP in Solr, Solr/Lucene, Tesseract Optical Character Recognition, and many other languages and software packages.

### Natural Language Processing

Embodiments of the present invention provide a method and a search engine that create automatic tags for preamble, elements/sub-elements and their attributes in the patent claims by segmenting the claims using natural language processing based algorithm. Since the core invention can be described using the independent and dependent claims, therefore the claim can be used to identify the details of the invention. The method uses a NLP (Natural Language Processing) based algorithm to identify the type of claims such as identifying whether the claim is a method claim, system claim or an apparatus claim among others. Similarly the nature of claim is identified using the NLP based algorithm to categorize the independent claims and the dependent claims, for example by searching for the word “claim” or numbers in the first few words. The method further uses the NLP based algorithm to segment independent claims into tags such as noun phrase, preposition phrase. The dependent claims are also segmented into tags for attributes of elements and sub-elements. The method ensures that the preamble, element and sub-elements and the attributes for each element/sub-elements are automatically tagged while the generic language components are not tagged, but may be incorporated into the element/sub-element tags or their attributes.

The Natural Language Processing engine contains a pipeline of blocks that (1) parse the patent into words separated by whitespaces (tokenizer), (2) tag the words with their grammatical part of speech (POS tagger), (3) chunk the tags into phrases of interest such as noun phrases, preposition phrases, verb phrases, adjective phrases, etc (chunker), (4) semantically tag the chunks into tags of interest such as claim preamble, elements, sub-elements, or their respective attributes.

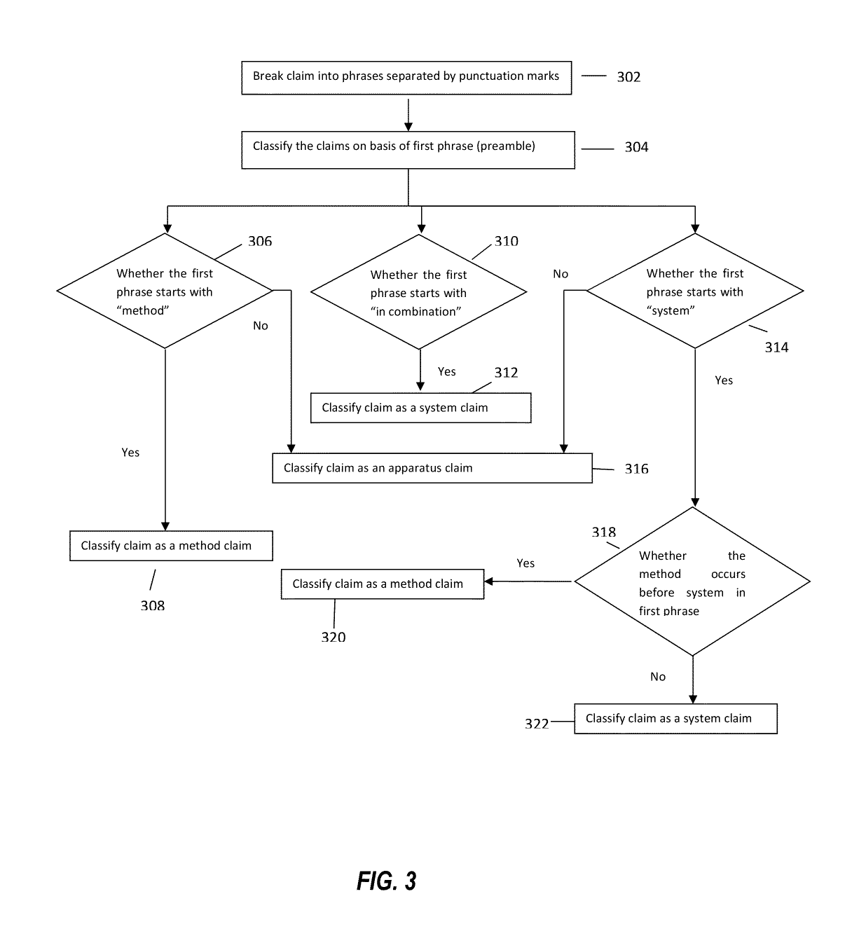

FIG. 3 shows a flow chart that describes a process to classify independent claim of a patent into a method claim, system claim or an apparatus claim using natural language processing based algorithm, in accordance with an embodiment of the present invention. The process starts with block 302 where the independent claim is broken down into phrases, separated by punctuation marks. The punctuation marks can be comma, semi-colon or colon. In block 304, the independent claim is classified on the basis of the first phrase, which is usually all or part of the preamble of the independent claim. In the decision block 306, it is determined whether the first phrase contains the word “method” in the first 2-3 words: if Yes, then the claim is classified as method claim in block 308 and if No, then other conditions are matched. In the decision block 310, it is determined whether the first phrase contains the word “combination” in the first 2-3 words: if Yes, then the system is classified as system claim in block 312. In the decision block 314, it is determined whether the first phrase contains the word “system” in the first 2-3 words: if No then the system is classified as an apparatus claim in block 316 if the claim also does not contain the word “method” in the first few words. If the response to decision block 314 is Yes, then the process further determines in block 318 whether the word “method” occurs before the word “system” in the first phrase: if yes, then the independent claim is classified as a method claim in block 320, and if No, then the independent claim is classified as a system claim in block 320.

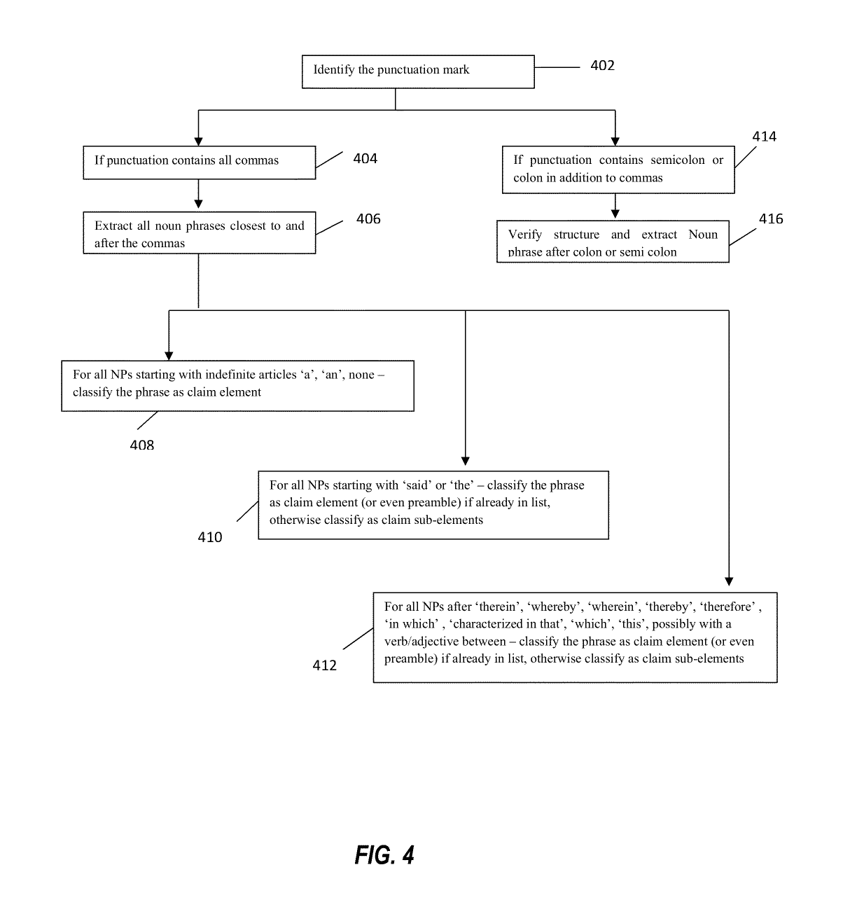

FIG. 4 shows a flowchart for identifying Noun Phrases (NP's) in an independent claim. The process begins by identifying punctuation marks in the independent claim as shown in block 402. If the punctuation contains only commas as shown in block 404, then all the Noun Phrases close to and after the commas are extracted, as shown in block 406, and analyzed to classify them into Noun Phrases containing elements (“element Noun Phrases”) and Noun Phrases containing sub-elements (“sub-element Noun Phrases”). All the Noun Phrases starting with indefinite articles: ‘a’, ‘an’ or no articles are classified as element Noun Phrases and stored, as shown in block 408. All the Noun Phrases starting with ‘said’ or ‘the’ are classified as element (or preamble) Noun Phrases if they were previously identified and stored as element Noun Phrases. If they were not previously identified as element Noun Phrases, they are classified as sub-element Noun Phrases, as shown in block 410. For all Noun Phrases after ‘therein’, ‘whereby’, ‘wherein’, ‘thereby’, ‘therefore’, ‘in which’, ‘characterized in that’, ‘which’, ‘this’, possibly with a verb/adjective between—the phrases are classified as element or preamble Noun Phrases if they were already identified as element Noun Phrases, otherwise they are classified as sub-element Noun Phrases, as shown in block 412.

After identifying the punctuation marks in step 402, if the punctuation contains semicolon or colon in addition to the commas, as shown in step 414, then the process proceeds towards verifying structure of the claim in terms of preamble and elements, and extracting Noun Phrases after colon or semi colon as depicted in step 416.

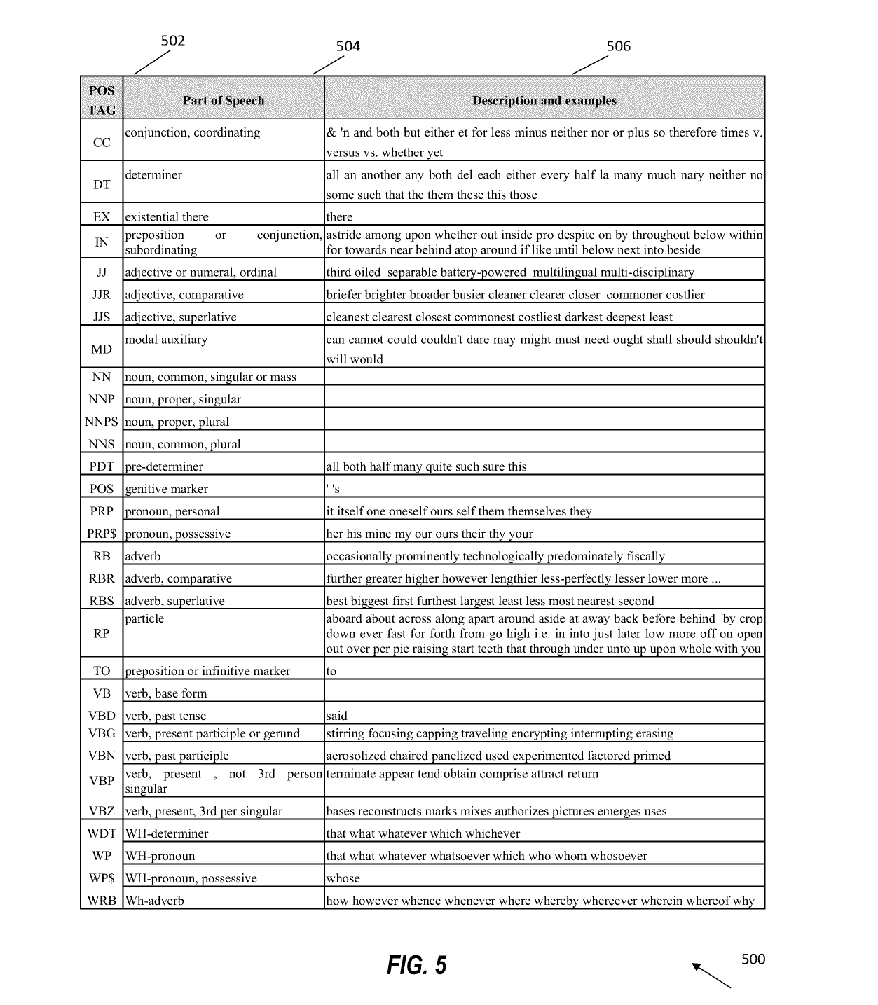

FIG. 5 shows a tabular representation of typical parts of speech (POS) in the English language that are used in the patent document to identify generic Noun Phrases (NP) and Preposition Phrases (PP), and Noun Phrases and Preposition Phrases that correspond to elements or sub-elements (NPE and PPE respectively) in accordance with an embodiment of the present invention. Table 500 shows three columns: the first column 502 shows the POS tags used by the natural language processing algorithms, the second column 504 shows the formal grammatical names of the POS, and the third column 506 describes the POS in detail with examples.

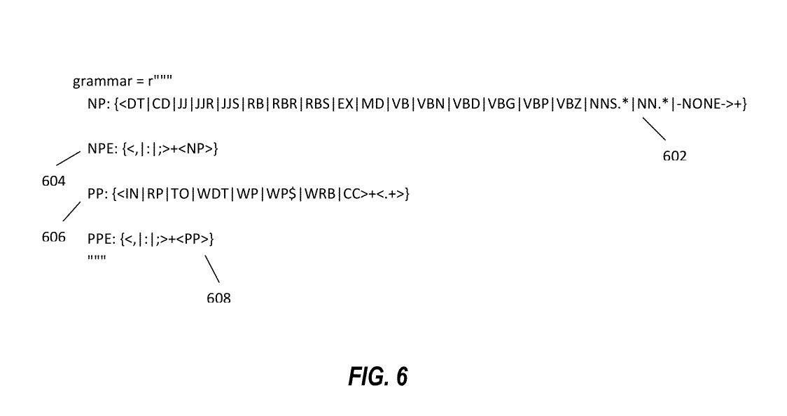

FIG. 6 represents the grammar used by the natural language processing algorithms to group sequential POS tags into NPs, NPEs, PPs and PPEs in accordance with an embodiment of the present invention. The generic Noun Phrase tags are assigned to segments of contiguous words that are all POS-tagged with any of the POS tags listed in 602. The NPs preceded by punctuation shown in 604 are tagged as NPEs. The generic Preposition Phrase tags are assigned to segments of contiguous words that are all POS-tagged with any of the POS tags listed in 606. The PPs preceded by punctuation shown in 608 are tagged as PPEs. The NPs, NPEs, PPs, and PPEs are then chunked together in carefully designed combinations and semantically tagged as preamble, element, sub-element, their respective attributes, etc.

In an alternate embodiment of the present invention, natural language processing algorithms may be modified to identify semantic tags of patents written in languages other than English, by identifying the appropriate grammar structures and parts of speech in those languages. Alternatively, natural language processing algorithms may be applied to English translations of patents originally written in non-English languages.

In alternate embodiment of the present invention, the economic value or monetary value can be attached in addition to the semantic analysis. The patents can be tagged at an element level with possible applications of the invention and the economic value of the applications. Then while preparing a query, these economic values can be used as second field, in addition to semantic analysis, to further refine the search results.

The method automatically creates a dictionary for each tag using external databases including synonyms, language/grammar dictionaries, technical taxonomies, academic publications, and library bibliographies. The dictionary additionally contains related terms from internal databases such as patent classes, other patents, or other fields in the patent being tagged. For example, the NLP algorithm extracts terms and definitions from the patent specification that are relevant to tags such as preamble, elements, and sub-elements.

In an embodiment of the present invention, the method can be used to create a patent database that contains patents with claims segmented in semantic tags and having a global dictionary that contains all the keywords that are present in all the patents with possible synonyms and technical terms.

In another embodiment of the present invention the method for semantic segmentation can be used in a patent search engine, thereby using the patents tagged with semantic segments in a database to do better searches by using queries that call out the specific tags.

In another embodiment of the present invention, a method for searching similar patents by generating keywords or search queries based on semantic segmentation of the claims is provided. When a search query is entered, the claims of the patent being searched are segmented into various fields namely preamble, key elements, and sub-elements. This segmentation is then used to create better, more accurate, search queries.

All of these segmentations and coding are done in an automated fashion thereby providing the user a very quick, visual, and easy way to assess the key semantic interpretation of the Claim. The method also enables the user to correct any faulty segmentation provided by the automated engine and to add user's own comments, thereby providing a powerful way to the user to correct interpretation of the Claim. This corrected or curated information could then also be used in any subsequent steps including annotation of patents for future use or sharing, creating better keywords or search strings.

Once the claims are semantically segmented and a better search query is generated using the segmentation, a query parser adds synonyms, technical taxonomy or technical terms using the global dictionary. The search query is then indexed to add sub field tags within claims to capture the WHAT, WHY and HOW elements. The method maps the semantic tags to match with the existing patents in the database and identifies the relevant patents showing similarity with the semantic tags. The scorer uses these semantic tags to rank the results by relevance and the result set containing the relevant patents are displayed to the user. The ranking algorithm uses the criteria where the patents that have more semantic tags matching with the query key words are ranked higher than those with less tags matching the query keywords. The method displays the closest patent classes based on query the keywords. It may also display some description of the top patents found to the user. It then asks for a selection, and if the user selects none of the result then the method displays more patent that are closer to the search query. The method searches deep in selected classes (using maximal class-specific synonyms, ranks by tags) and if the user wants more, then the method searches in other classes by selecting alternative synonyms. The ranking algorithm of the method provides the option of ranking the relevant closest patent by field: title, abstract, claim tags, claims, description, references and rank by proximity.

In one embodiment of the invention one or more searches performed can be saved in a search history and made available to the user to selectively edit and recompose from, to converge faster to the correct results.

In an embodiment of the present invention, a search engine is provided that utilizes the method for searching similar patents by generating keywords based on semantic segmentation of the claim, as described above. The search engine is based on performing search for closest patents using the semantic segmentation of claims, tagging the claims for generating keywords and mapping the generated keywords for identifying the closest patent. The keywords are mapped to the patents stored in the patent database. The mapping of the keywords based on semantic segmentation of claims is performed by semantically segmenting the claims of patents stored in the patent database.

### Patent Representation and Search

FIG. 2 illustrates the process used by a search engine based on keyword search for identifying similar patents. The process 200 used by the search engine 200 starts with a user entering a search query into a user interface 202. A query parser 204 parses the search query for spell check and typically expands it with keyword synonyms. The re-written query goes into an index 206, which is a dictionary mapping all the keywords to the patents and searchable patent fields they occur in. The index 206 yields a list of found patents ranked by top matches, and a scorer 208 assigns weighted scores to the ranked list to obtain the final results, which are delivered to the display (which is usually part of the user interface 202). The scorer may be trained on a small test data set to optimize the precision and recall of the search engine, where precision measures the relevance of results and recall measures the coverage of results.

The typical search query consists of keywords or phrases. According to this invention the search query may consist of one or more of: keywords, phrases, pseudo-claims, segments, tags, tag dictionaries, tags and segments viewed by means of a user interface, and tags and segments edited by means of a user interface. The user interface 202 is described in more detail in a later section.

A simple representation model for the search engine as described in the embodiment of the present invention that captures the typical capabilities provided by the existing search engines and build it up to the semantic model is described below. Remarks on notation used in the following equations: lowercase unbolded variables are scalars, lowercase bolded variables are row vectors (special cases: 1=vector of all ones, 0=vector of all zeros, 1_{[i]}=vector of ones and zeros with ones at location (or indices) marked in the set [i]), uppercase unbolded variables are constants, uppercase bolded variables are matrices, a[i] is the value in the i^{th} location of a, A[i,j] is the value in the i^{th} row and j^{th} column of A, for a 1×A vector a the 1-norm is defined as |a|=Σᵢ₌₁^{i=A}|a[i]|, the transpose of row vector a is the column vector a′, the inner product of two 1×K vectors is defined as ab′=Σᵢ₌₁^{i=K}a[k]b[k].

A global dictionary with a list of global keywords is assumed to exist, which includes all possible keywords that occur in the database of patents. Some of these keywords may not occur in any patents but may be used in search queries, e.g. as synonyms. The global dictionary is described as a row vector g in Equation 1. These keywords may be single words or phrases of co-occurring words such as n-grams, where n is typically 2 or 3. They may be listed in ascending or descending alphabetical order, or some other order suitable to speedy implementation in hardware.

Global keyword dictionary (1×K) g=[g₁ . . . gₖ . . . g_{K}]

Equation 1: Dictionary of all Possible Keywords as a 1×K Vector, where K is Very Large

A patent contains some of these keywords (not in the same order as in g), and can be represented as an indicator vector or incidence vector relative to g. As shown in Equation 2, the indicator vector has zeros everywhere except at the indices where the patent contains words in common with g, where it is equal to ‘1’. While a simplest representation of a patent as an indicator vector with ‘1’s to indicate presence of the corresponding keyword in g is used, more advanced representations may be used, such as those taking into account the number of occurrences of the keyword.

The u^{th} patent as an indicator vector (1×K) pᵤ=1_{[u]}=[0 . . . 1_{[u]} . . . 0], |pᵤ|=total keywords in patent

Equation 2: Representation of a Patent as an Indicator Vector Relative to Dictionary g—with ‘1’s at Indices where Patent Keywords Occur in g

All patent indicator vectors can be stacked up to represent the entire database of patents as a matrix, shown for a database with U patents in Equation 3.

$$Representation of the patent database as a martrix \\ Patent database as a matrix ( U \times K ) P = [ \begin{matrix}{p}_{1} \\ ⋮ \\ {p}_{u} \\ ⋮ \\ {p}_{U}\end{matrix} ] , \\ U = number of patents in a database \qquad Equation 3$$

Note that any database can be represented in this fashion, in particular the patent classes and their descriptions can be represented in the manner described here and searched for in the manner described in the following.

The user's Search Query consists of a bunch of keywords, which can also be represented as an indicator vector relative to g as shown in Equation 4. As mentioned earlier, the dictionary is assumed to contain all possible user query keywords, which makes this representation possible. For simplicity, it is assumed that the query keywords are distinct, i.e. none of them are repetitions.

Search Query keywords as an indicator vector (1×K) q=1_{[q]}=[0 . . . 1_{[q]} . . . 0], |q|=total keywords in query

### Equation 4: Representation of a Search Query as an Indicator Vector Relative to g

### Patent Rank in Search Result

When the user performs a search, the query keyword is matched against all patents. This is mathematically shown Equation 5, where a nominal ‘rank’ of patent pᵤ against query q is defined. The more the query words found in the patent, the higher is its rank Note that this vector product is properly defined because both the patent and query are represented consistently relative to the same global dictionary.

Nominal search rank of the u^{th} patent rᵤ=pᵤq′=Σₖ₌₁^{k=K}pᵤ[k]q[k]

Equation 5: Rank of a Patent Defined as the Inner Product of a Patent with Query

Search rank of all patents in the database is a vector as shown in Equation 6. This nominal rank measures the query keyword count in each patent.

$$Rank list of all patents against query q \\ Rank list ( U \times 1 ) r = {Pq}^{′} = [ \begin{matrix}{p}_{1} {q}^{′} \\ ⋮ \\ {p}_{u} {q}^{′} \\ ⋮ \\ {p}_{U} {q}^{′}\end{matrix} ] = [ \begin{matrix}{r}_{1} \\ ⋮ \\ {r}_{u} \\ ⋮ \\ {r}_{U}\end{matrix} ] \qquad Equation 6$$

### Operators in Search Query

Search Query operators can be mathematically implemented by selecting patents with certain rank values against the query as shown in Equation 7.

$$\begin{matrix} Search operators \\ \begin{matrix} AND ( all keywords in q ) = \{ all {p}_{i} such that {r}_{i} = \vert q \vert \} \\ = submatrix {P}_{AND} of P \\ such that {P}_{AND} {q}^{′} \\ = \vert q \vert 1\end{matrix} & Equation 7 \\ \begin{matrix} OR ( all keywords in q ) = \{ all {p}_{i} such that {r}_{i} \geq 1 \} \\ = submatrix {P}_{OR} of P such \\ that {P}_{OR} {q}^{′} \geq 1\end{matrix} & \\ \begin{matrix} XOR ( all keywords in q ) = \{ all {p}_{i} such that {r}_{i} = 1 \} \\ = submatrix {P}_{XOR} of P such \\ that {P}_{XOR} {q}^{′} \\ = 1\end{matrix} & \\ \begin{matrix}ANDNOT ( all keywords in q ) = \{ all {p}_{i} such that {r}_{i} = 0 \} \\ = submatrix {P}_{ANDNOT} of \\ P such that {P}_{ANDNOT} {q}^{′} \\ = 0\end{matrix} & \end{matrix}$$

Note that the per-operator conditions described on submatrices Pₒₚ in Equation 7 are element-wise conditions on each element of the column vector rₒₚ=Pₒₚq′. To implement combinations of operators, successive operators can be applied on successive submatrices, as shown in Equation 8 for the example query=(OR (all keywords in q₁)) AND (OR (all keywords in q₂)).

OR on q₁=>take submatrix P₁ of P such that P₁q₁′≧1,

OR on q₂=>take submatrix P₂ of P such that P₂q₂′≧1,

if P₁ is the smaller than P₂, result=submatrix P̅₁̅ of P₁ such that P̅₁̅q₂′≧1;

if P₂ is the smaller than P₁, result=submatrix P̅₂̅ of P₂ such that P̅₂̅q₁′≧1.

### Equation 8: Combinations of Search Operators

More sophisticated methods using advanced algebra may be applied for applying complex operators to complex queries. For example, operators can be implemented as a non-linear function φ as shown in Equation 9.

Rank list after operators (Ū×1) r̅=φ(r)=φ(Pq′) where Ū≦U

### Equation 9: Operators as a Non-Linear Function on Rank List

### Query Synonyms and Query Expansion

Synonyms may be added to the query by asking for user input or by automatically accessing a language dictionary (WordNet) or technical taxonomies (IEEE Explore, Library of Congress, PubMed etc). For each query keyword qᵢ in the query vector q (total keywords=sum of nonzero positions=|q|), synonyms are represented as indicator vectors relative to g and then added to the keyword as shown in Equation 10 (assuming they are all distinct, and different from the keyword). This is done for one query keyword at a time, qᵢ=1_{[i]} has only one nonzero entry at the location contained in [i]. The corresponding synonym vector q_{i,syn} has nonzero entries at locations contained in [q_{i,syn}], representing all included synonyms of qᵢ.

Break up q into single-keyword indicator vectors q=Σᵢ₌₁^{i=|q|}qᵢ=Σᵢ₌₁^{i=|q|}1_{[i]}

Synonyms as an indicator vector q_{i,syn}=1_{[q}_{_{i,syn}}_{]}=[0 . . . 1_{[q}_{_{i,syn}}_{]}. . . 0], |q_{i,syn}|=total synonyms for the i^{th} keyword

New query vector for qᵢ=\hat{q}ₗ=qᵢ+q_{i,syn}

New rank for \hat{q}ₗ=\hat{r}=p\hat{q}ₗ′=p(qᵢ+q_{i,syn})′=r+pq_{i,syn}′≧r

To perform OR of {keyword, synonyms} in \hat{q}ₗ, take submatrix Pₛ of P such that Pₛ\hat{q}ₗ≧1

### Equation 10: Representation of Search Query Synonyms as an Indicator Vector Relative to g

The additive operation increases the rank as it finds more potential matches. In other words, for a fixed rank threshold above which patents are returned in results, this increases the number of returned patents, as expected by adding synonyms.

This per-keyword operation can be compactly expressed by the more general method of Query Expansion. Most search engines use query expansion to conduct parallel searches. This can be implemented as an expansion of the query vector to a matrix as shown in Equation 11.

$$Query Expansion represented as a matrix \\ Query Matrix ( Q \times K ) Q = [ \begin{matrix}{q}_{1} \\ ⋮ \\ {q}_{i} \\ ⋮ \\ {q}_{Q}\end{matrix} ] , \\ Q = number of queries after expansion \\ Rank Matrix ( UXQ ) \\ \begin{matrix}R = [ \begin{matrix}{r}_{1} & … & {r}_{i} & … & {r}_{Q}\end{matrix} ] \\ = {PQ}^{′} \\ = [ \begin{matrix}{Pq}_{1}^{′} & … & {Pq}_{i}^{′} & … & {Pq}_{Q}^{′}\end{matrix} ]\end{matrix} \qquad Equation 11$$

This outputs a rank matrix, with columns corresponding to input query rows. For general query expansion, this rank matrix can be further analyzed to derive optimal results, e.g. to tune the search engine by adjusting weights described elsewhere in this document. For our case of synonyms, this format makes it easy to add synonyms independently to each keyword row as shown in Equation 12.

$$Synonyms implemented as Query Expansion \\ Query Matrix with synonyms = \hat{Q} = [ \begin{matrix}\hat{{q}_{1}} \\ ⋮ \\ \hat{{q}_{i}} \\ ⋮ \\ \hat{{q}_{Q}}\end{matrix} ] = [ \begin{matrix}{q}_{1} \\ ⋮ \\ {q}_{i} \\ ⋮ \\ {q}_{Q}\end{matrix} ] + [ \begin{matrix}{q}_{1 , syn} \\ ⋮ \\ {q}_{i , syn} \\ ⋮ \\ {q}_{Q , syn}\end{matrix} ] = Q + {Q}_{syn} , \\ Q = \vert q \vert \\ For each query keyword i , \\ take submatrix {P}_{i} of P such that {P}_{i} {\hat{q}}_{i} \geq 1 ( to perform OR of keyword + synonyms ) , \\ then combine the set \{ {P}_{i} \} based on user input operators as demonstrated in Equation 8. \qquad Equation 12$$

### Weighting Search Rank by Keyword Proximity

Proximity of Search Query keywords is another feature offered by most modern patent search engines. As shown in Equation 13, it can be added to our model as a diagonal weighting matrix W(q) that is a function of the query. Each proximity weight wᵤ(q) is inversely proportional to the distance spanned by query keywords q occurring in patent pᵤ. It may be defined simply as wᵤ(q)=1/(1+δ(q)) where δ(q)=the minimum number of words separating all keywords in query, i.e. words between the first occurring keyword and the last occurring keyword in the patent (excluding the keywords), over all occurrences of the keywords in the patent. Other definitions may be used, for example to account for cases when only some of the keywords are found (i.e., rᵤ<|q|). In order to differentiate the weighted rank from the pure (keyword count) rank, we call the weighted rank a ‘score’ instead.

$$Proximity weighted patent score \\ Proximity weighted patent score s = W ( q ) r = [ \begin{matrix}{w}_{1} ( q ) & … & 0 & … & 0 \\ ⋮ & & ⋮ & & ⋮ \\ 0 & … & {w}_{u} ( q ) & … & 0 \\ ⋮ & & ⋮ & & ⋮ \\ 0 & … & 0 & … & {w}_{U} ( q )\end{matrix} ] {Pq}^{′} = [ \begin{matrix}{w}_{1} ( q ) {p}_{1} \\ ⋮ \\ {w}_{u} ( q ) {p}_{u} \\ ⋮ \\ {w}_{U} ( q ) {p}_{U}\end{matrix} ] {q}^{′} \qquad Equation 13$$

Note that for any kind of rank weighting, application of search operators becomes trickier, and it is generally easiest to apply search operator selections to the rank list before applying weights. An alternative implementation of query expansion shown in Equation 14 may be useful for weighting scores. The query vector is expanded into a Q-times longer vector containing alternative queries (for example synonym-expanded keywords described earlier), and the patent matrix is replicated into a diagonal matrix. The resulting rank vector is a Q-times longer vector that can be weighted by any meaningful weight matrix V.

$$Query Expansion represented as an extended vector \\ Expanded Query vector \\ ( 1 \times KQ ) q = [ \begin{matrix}{q}_{1} & … & {q}_{i} & … & {q}_{Q}\end{matrix} ] , \\ Expanded Patent Martrix \\ ( UQ \times KQ ) \hat{P} = [ \begin{matrix}P & … & 0 & … & 0 \\ & & ⋮ & & \\ 0 & … & P & … & 0 \\ & & ⋮ & & \\ 0 & … & 0 & … & P\end{matrix} ] \\ Expanded Rank vector ( UQ \times q ) \\ \hat{r} = \hat{P} {q}^{′} = [ \begin{matrix}{Pq}_{1}^{′} \\ ⋮ \\ {Pq}_{i}^{′} \\ ⋮ \\ {Pq}_{Q}^{′}\end{matrix} ] = [ \begin{matrix}{r}_{1} \\ ⋮ \\ {r}_{i} \\ ⋮ \\ {r}_{Q}\end{matrix} ] \\ Weighted Score ( U \times 1 ) \hat{s} = V \hat{r} , \\ V is a generic weight matrix ( U \times UQ ) \qquad Equation 14$$

Let us use the notation from Equation 14 to re-do with synonyms the proximity example of Equation 13. The re-done example is shown in Equation 15, where q contains the per-keyword synonym vectors \hat{q}ₗ defined in Equation 10, V contains the keyword proximity weights vᵤ(q) defined similarly to wᵤ(q) in Equation 13, for each patent u that survives operation φ (submatrix selection shown in Equation 12).

$$Proximity weighted patent score with query synonyms \\ Weighted Score ( \overline{U} \times 1 ) \\ \hat{s} = V ( q ) ϕ ( \hat{r} ) = [ \begin{matrix}{v}_{1} ( q ) & … & 0 & … & 0 \\ ⋮ & & ⋮ & & ⋮ \\ 0 & … & {v}_{u} ( q ) & … & 0 \\ ⋮ & & ⋮ & & ⋮ \\ 0 & … & 0 & … & {v}_{\overline{U}} ( q )\end{matrix} ] ϕ ( \hat{r} ) \qquad Equation 15$$

### Weighting Search Rank by Patent Class

In more sophisticated engines, information about patent classes may be used to improve search. For example, the most frequent keywords in each class may be identified and tagged in the patent database matrix P. When the query keywords contain these class words, patents in that class may be weighted higher. Class weights can be incorporated similarly to proximity weights, as shown in Equation 16, as a diagonal weighting matrix C(q) that is a function of the query, and each weight cᵤ(q) is a function of the patent's class and query. Weights can be set to 1 and 0s to select any particular class.

$$\begin{matrix}Patent Class weighted patent score \\ Class weighted score ( U \times 1 ) & Equation 16 \\ \begin{matrix}s = C ( q ) r \\ = [ \begin{matrix}{c}_{1} ( q ) & … & 0 & … & 0 \\ ⋮ & & ⋮ & & ⋮ \\ 0 & … & {c}_{u} ( q ) & … & 0 \\ ⋮ & & ⋮ & & ⋮ \\ 0 & … & 0 & … & {c}_{U} ( q )\end{matrix} ] {Pq}^{′} \\ = [ \begin{matrix}{c}_{1} ( q ) {p}_{1} \\ ⋮ \\ {c}_{u} ( q ) {p}_{u} \\ ⋮ \\ {c}_{U} ( q ) {p}_{U}\end{matrix} ] {q}^{′}\end{matrix} & \end{matrix}$$

Technology-specific phrases and acronyms are often important in patent classes. As an alternative to n-grams which are computationally intensive to index, a simpler way to implement class-specific phrase search is to apply proximity weights in conjunction with class weights.

### Weighting Search Rank by Patent Field

Almost all search engines offer search within patent fields such as Title, Abstract, Claims, Specification etc. This can be easily incorporated into our model by representing each field as an indicator vector against the dictionary g, and adding them to the patent vector. The patent vector extends to a patent matrix, with each row representing a field of the patent as shown in Equation 17 for total F fields, including the original full patent as field.

$$Patent fields as an indicator matrix \\ Patent ’ s matrix ( F \times K ) {P}_{u} = [ \begin{matrix}{t}_{u} \\ {a}_{u} \\ {c}_{u} \\ {s}_{u} \\ {p}_{u} \\ ⋮\end{matrix} ] , \\ F ( 1 \times K ) field vectors \text{:} \begin{matrix}\begin{matrix}\begin{matrix}\begin{matrix}{t}_{u} = Title \\ {a}_{u} = Abstract\end{matrix} \\ {c}_{u} = Claims\end{matrix} \\ {s}_{u} = Specifications\end{matrix} \\ {p}_{u} = full patent \\ … other fields\end{matrix} \qquad Equation 17$$

Patent fields can also be weighted to emphasize certain fields over others. Academic literature shows that keyword searches in Title, Abstract and Claims tend to yield more accurate results than searches in Specification. Therefore a simple way to improve relevance of results is to weight these fields higher than Specification. Equation 18 illustrates weighting by fields. Weights can be set to 1 and 0s to select any particular field. The weights shown are uniform across patents and may be made a function of class, for example to de-emphasize fields that are known to be sparse in certain classes.

$$Patent Field weighted patent score \\ Field weighted score s = Fr = [ \begin{matrix}f & … & 0 & … & 0 \\ ⋮ & & ⋮ & & ⋮ \\ 0 & … & f & … & 0 \\ ⋮ & & ⋮ & & ⋮ \\ 0 & … & 0 & … & f\end{matrix} ] {Pq}^{′} , \\ ( 1 \times F ) Weight vector f = [ {f}_{t} {f}_{a} {f}_{c} {f}_{s} … ] \qquad Equation 18$$

### Adding Tags such as “Elements” to Searchable Patent Fields

Embodiment of the present invention proposes semantic segmentation of Claims with enhancement from other fields, to create new searchable fields from Tags. An example of tags called “Elements” is shown in Equation 19. “Elements” centers around the invention elements described in Claims, and enhances them by pulling in relevant content from the Title, Abstract and Specification. Details of how “Elements” and other Tags are created were described in the previous section. This invention further proposes designing the weight vector judiciously to improve search results—by taking advantage of the fact that Tags such as Elements are semantically curated fields and should generally be weighted higher than other fields. In some cases, optimally designed Tags fields may be exclusively used for high relevance search, over any other fields.

$$\begin{matrix}Semantic Tags , & Equation 19 \\ in particular “ Elements ” as a new patent field \\ Patent ’ s indicator matrix {P}_{u} = [ \begin{matrix}{t}_{u} \\ {a}_{u} \\ {c}_{u} \\ {e}_{u} \\ {s}_{u} \\ {p}_{u}\end{matrix} ] , \\ F ( 1 \times K ) field vectors \text{:} \begin{matrix}\begin{matrix}\begin{matrix}\begin{matrix}\begin{matrix}{t}_{u} \\ {a}_{u}\end{matrix} \\ {c}_{u}\end{matrix} \\ {e}_{u} = Elements\end{matrix} \\ {s}_{u}\end{matrix} \\ {p}_{u}\end{matrix} & \end{matrix}$$

The relative expected lengths of existing and proposed patent fields are schematically shown in Equation 20 by dashed lines.

$$Equation 20$$

$$Relative length of different patent fields \\ [ \begin{matrix}{t}_{u} - \\ {a}_{u} -- \\ {c}_{u} -- -- -- \\ {e}_{u} -- -- -- -- -- -- \\ {s}_{u} -- -- -- -- -- -- -- -- -- -- -- -- -- -- -- --\end{matrix} ]$$

### User Interface and Display

Another embodiment of the present invention is a user display (User Interface) that utilizes the novel semantic segmentation technique as described in the previous embodiments of the invention. This user interface is used in analyzing any given patent or document and provides a unique method of viewing different segments of that patent (or document) in a way that provides the user very critical information towards understanding that patent (or document). The user can then use and modify this information to perform various steps. These steps may involve, but are not restricted to, providing better information or keywords for searching a specific concept or patent, doing a more thorough due diligence of a particular patent or technical document, and annotating the patent or technical document for future use or sharing.

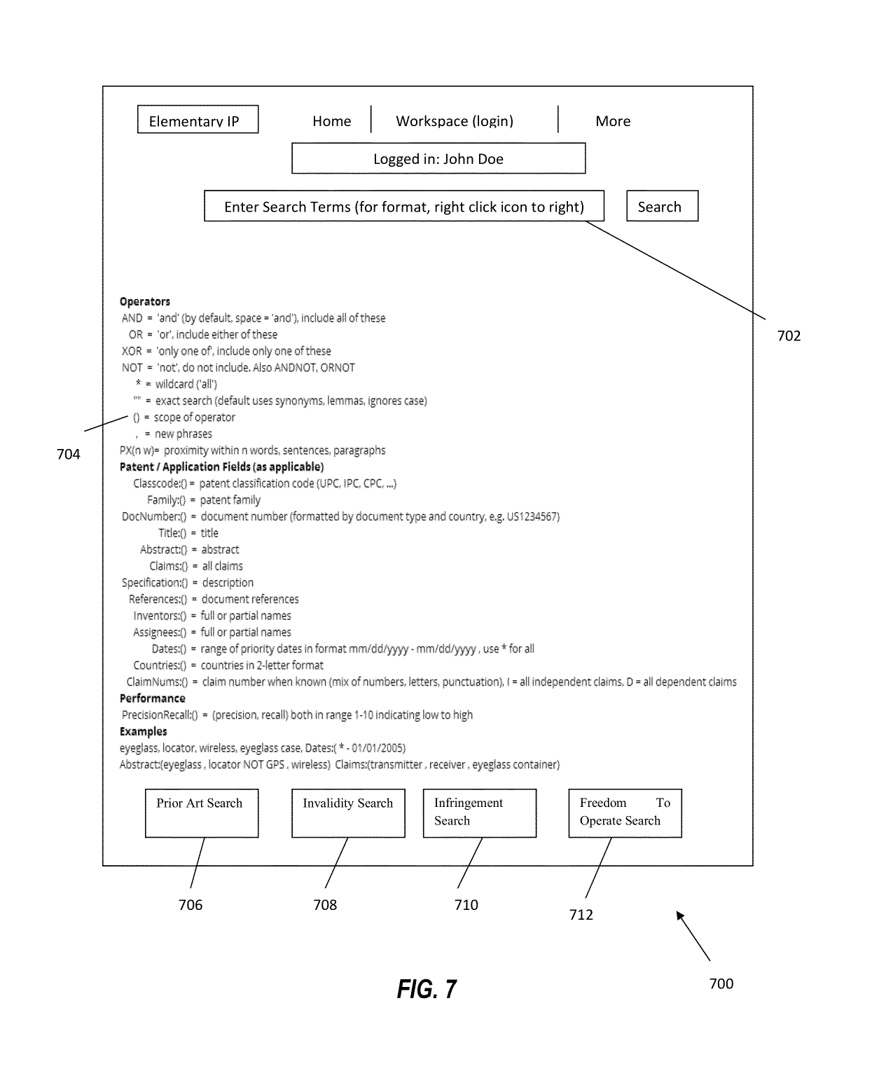

FIG. 7 shows an advanced user interface for systematically representing a patent claim or the concept that the user is interested in analyzing. The user interface 700 provides an effective way to the user for analyzing the patent claims or a concept and can be used both for understanding a given patent or concept or searching based on that. The user interface 700 provides such as Home, User log-in where the user can enter his credential to log-in into the search engine. The user interface 700 consists of a search box 702 where user can enter the number of the patent which the user wants to search for or to analyze the claims. The user interface 700 provides a list 704 of Boolean operators and the various fields for searching the database. The user can refine his query by using Boolean operators or using a combination of different field as shown in list 704. The user interface further provides controls of search precision and recall to the user, to control the number of search results displayed and their quality of relevance. The user interface 700 provides the option to the user for selecting the type of search using the semantic segmentation representation, and guides the user in the search by highlighting necessary search options that must be filled. The types of studies that can be performed using the interface 700 are Prior art Search 706, Invalidity Search 708, Infringement search 710 and Freedom to operate search 712.

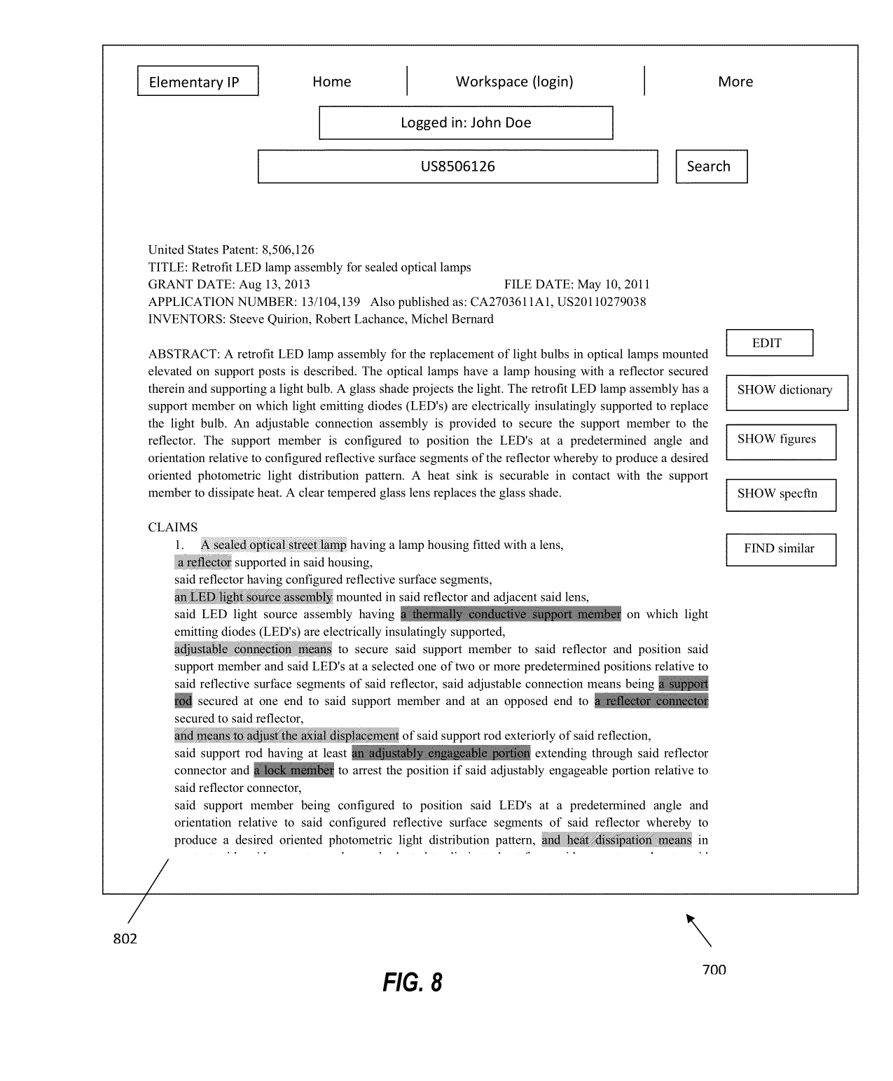

FIG. 8 shows a user interface of semantic-segmentation based search model displaying color coded claim segments in accordance with an embodiment of the present invention. When a new patent number as search query is entered in the search box 802 of the user interface 700, the method provides a way to display the Claims of this patent in a unique segmented way 802. The Claim is broken down into various fields namely preamble, key elements, and sub-elements. Each of these fields is color coded in an automated fashion. For example, in the user interface 700, the preamble is coded in light grey, the key elements are coded in grey, and sub-elements are coded in dark grey. Note that all of these segmentations and color coding are done in an automated fashion thereby providing the user with a very quick, visual, and easy way to assess the key semantic interpretation of the claim. The tags and segments can be displayed to the user in different formats to accelerate comprehension, the formats being user selectable and comprising one or more of font colors, font types, font sizes, indentations, 3-D effects such as raised or lowered fonts, and animation effects. The tags and segments can further be displayed in different display aspects with respect to the patent being tagged, the aspects comprising one or more of overlay, partial overlay, translucent overlay, movable overlay, sidebar, footnote, separate screen, separate display, extended display, and full or partial 3D display. The tags and or segments can be selectively displayed, and can be saved or shared based on user identity, application type, document state, user state, or other metrics.

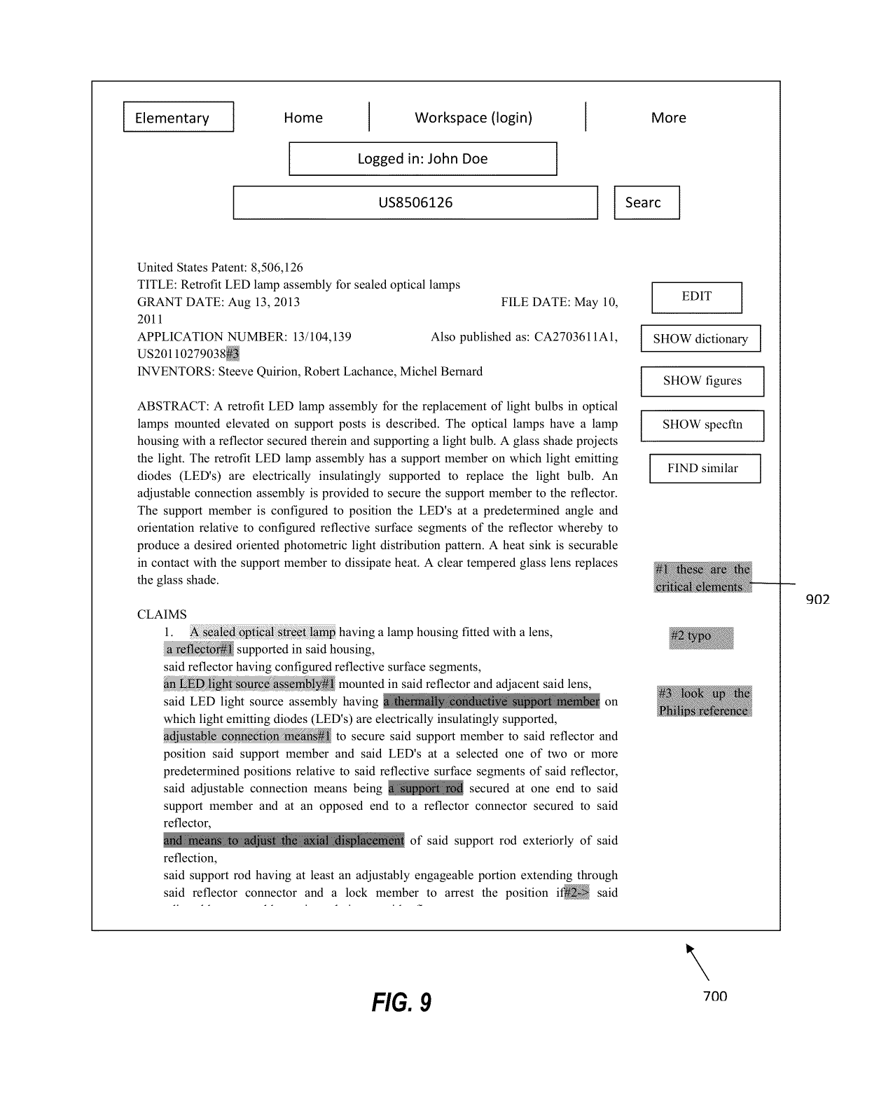

In another embodiment of this invention, the user is also provided with a way to edit the tags and segments, for example to correct any errors occurring in the automated NLP engine. FIG. 9 shows the user interface of semantic-segmentation based search model that allows the user to edit the semantic tag claim segments and to add the user's comments in accordance with an embodiment of the present invention. The user interface 700 provides a method where the user is given an ability to correct or add his own comments 902. This provides a powerful way for the user to correct the interpretation of the Claim. In particular, users involved in prosecution or litigation can add comments describing why particular claims or elements are important or irrelevant to a particular party, or where a particular element is introduced, defined or construed. This corrected or curated information could then also be used in any subsequent steps including creating better keywords or search strings. The user can choose to view, edit, annotate, or save the segments or tags, including the tag dictionaries, or share them with other users. The user can choose to search patent databases with search queries constructed from all or part of the viewed, edited, annotated, saved or shared segments and tags.

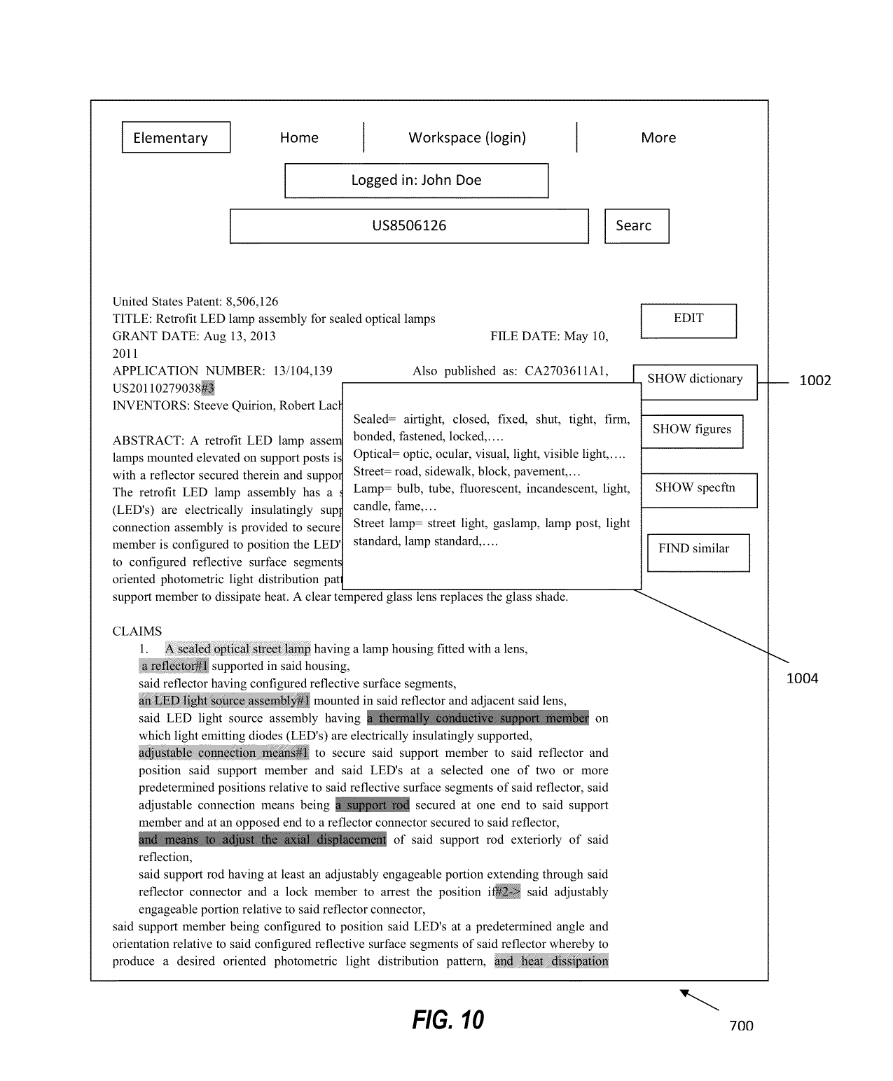

In another embodiment of this invention the user is also provided with an automated way to show possible synonyms or technical mapping (taxonomy) of any selected word group. FIG. 10 shows a user interface of semantic-segmentation based search model displaying claim segments with active links—a pop up dictionary, in accordance with an embodiment of the present invention. The user interface 700 shows the selected word group is the preamble (coded in light grey). The user can see the various synonyms of the selected text by selecting button: show dictionary 1002. A ‘pop-up’ window 1004 will appear where all the words in the segments are shown with their possible synonyms. In another embodiment of this invention, the ‘pop-up’ window 1004 may show not only the synonyms, but also, all possible taxonomies or technical mappings of the selected word group. In another embodiment, the user may hover with the mouse or other selector on the segment of interest and the dictionary may automatically pop-up. In another embodiment, the user may right click, left click, or otherwise perform an action on the segment to have the dictionary pop up.

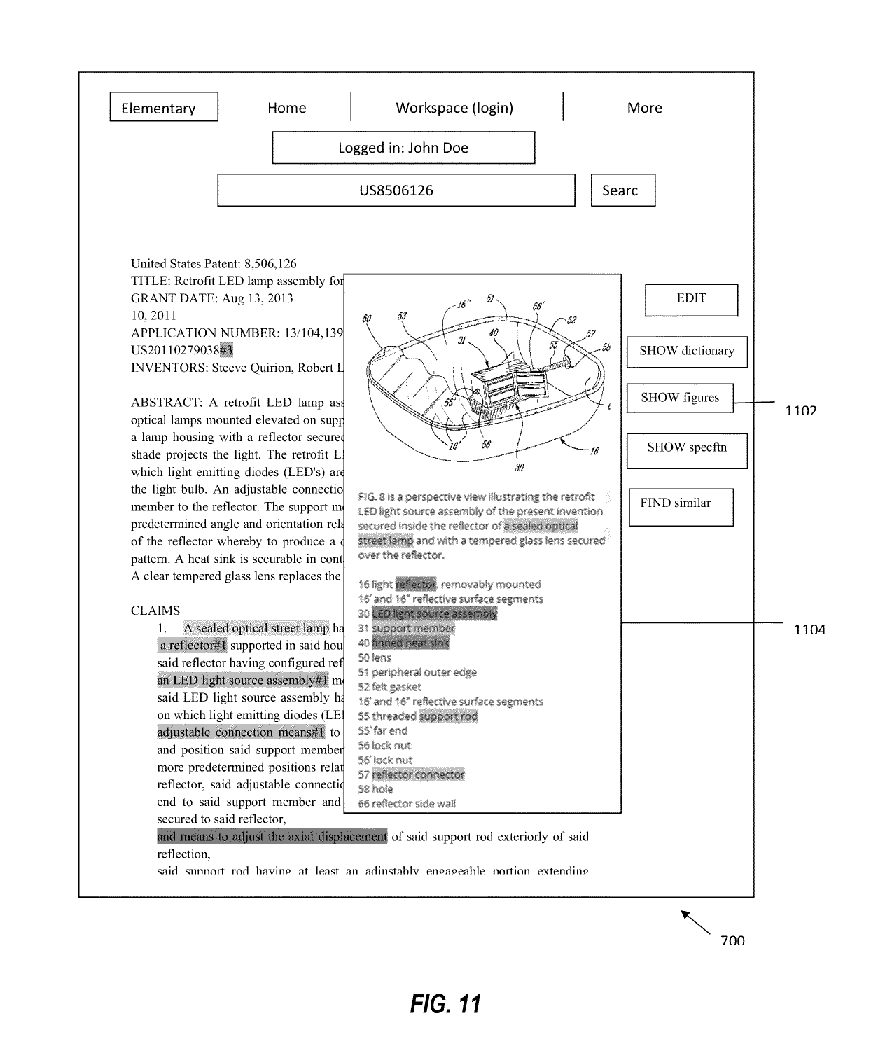

In another embodiment of this invention, the user is provided with a method to automatically extract and display the relevant figure from the patent along with a description of the figure and a legend of components labeled in the figure. FIG. 11 shows a user interface of semantic-segmentation based search model displaying claim segments with active links—pop up figures with legend, in accordance with an embodiment of the present invention. Upon clicking a particular segment in the user interface 700, the user is able to see the most relevant figure related to this Claim as a pop-up 1104 using show figure button 1102. In addition to the figure, the key tag segments (preamble, elements, and sub-elements) are also automatically mapped to the figure. Although FIG. 11 describes the representation of figure with relevant text in a pop-up window, it will be obvious to a person with knowledge of patents and user interface that there are many other ways to represent this concept. In another embodiment, the user may hover with the mouse or other selector on the segment of interest and the figure may automatically pop-up. In another embodiment, the user may right click, left click, or otherwise perform an action on the segment to have the figure pop up.

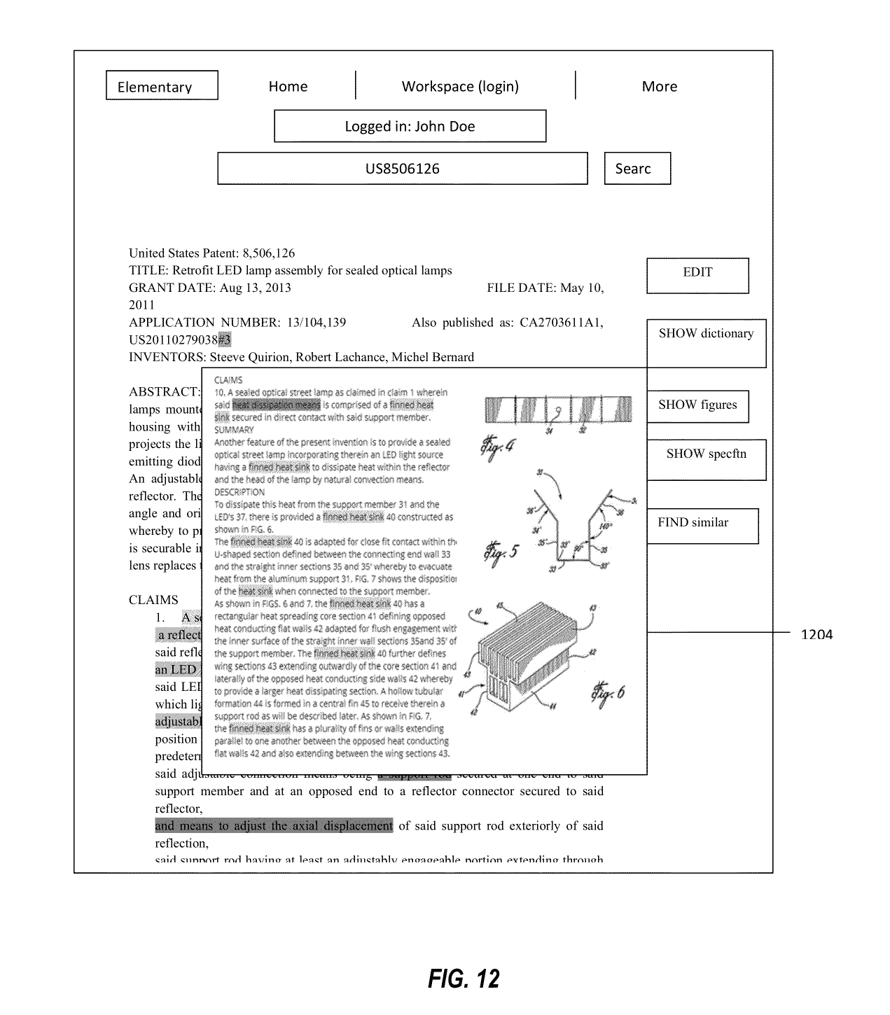

In another embodiment of this invention the user is also provided a method of automatically seeing the relevant word segments from various parts of the patent specification. The user is given an ability to select any specific word or tag. FIG. 12 shows a user interface of semantic-segmentation based search model displaying claim segments with active links—pop up specification references and their referred figures, in accordance with an embodiment of the present invention. The method provides a way to show a pop-up display 1204 that shows relevant sections from the patent specification that maps to the selected word or tag. In another embodiment, the user may hover with the mouse or other selector on the segment of interest and the specification quote may automatically pop-up. In another embodiment, the user may right click, left click, or otherwise perform an action on the segment to have the specification quote pop up.

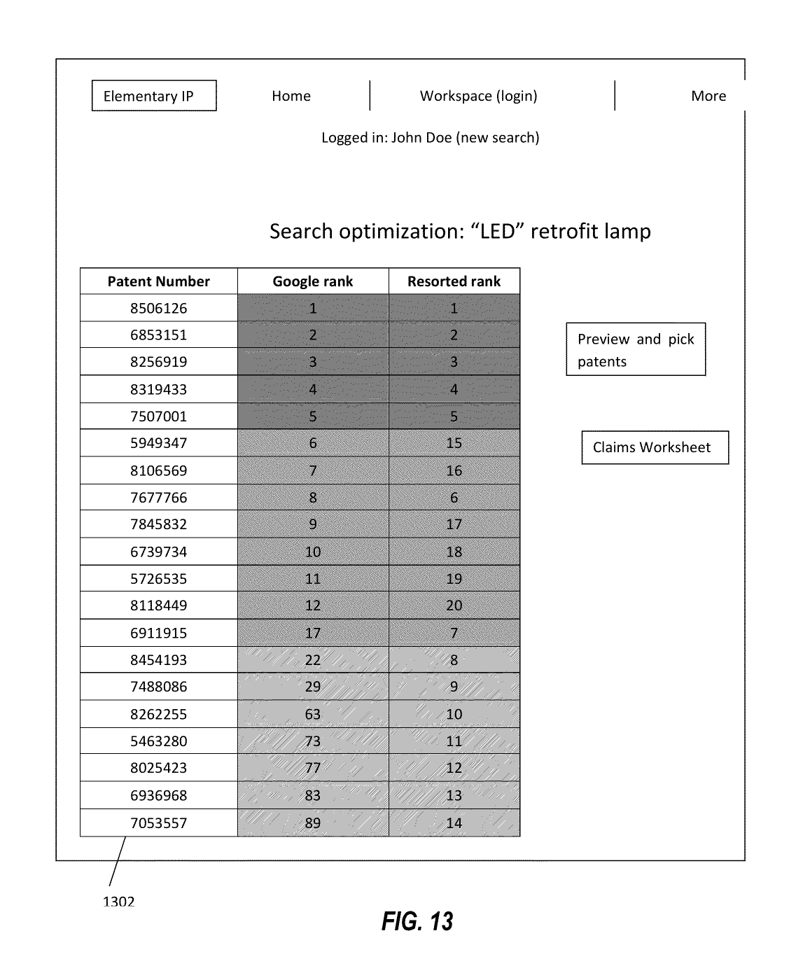

FIG. 13 shows a user interface displaying the result set with scores based on semantic tags, in accordance with an embodiment of the present invention. The search results from a typical search engine such as Google are also displayed as shown in table 1302. In another embodiment of this invention, the display provides an ability to compare the semantic tagging search results side by side with the search results from other competitive search engines. The invention further provides the user with ability to select patent from one or more of these ranked lists, for further analysis or inclusion in new searches.

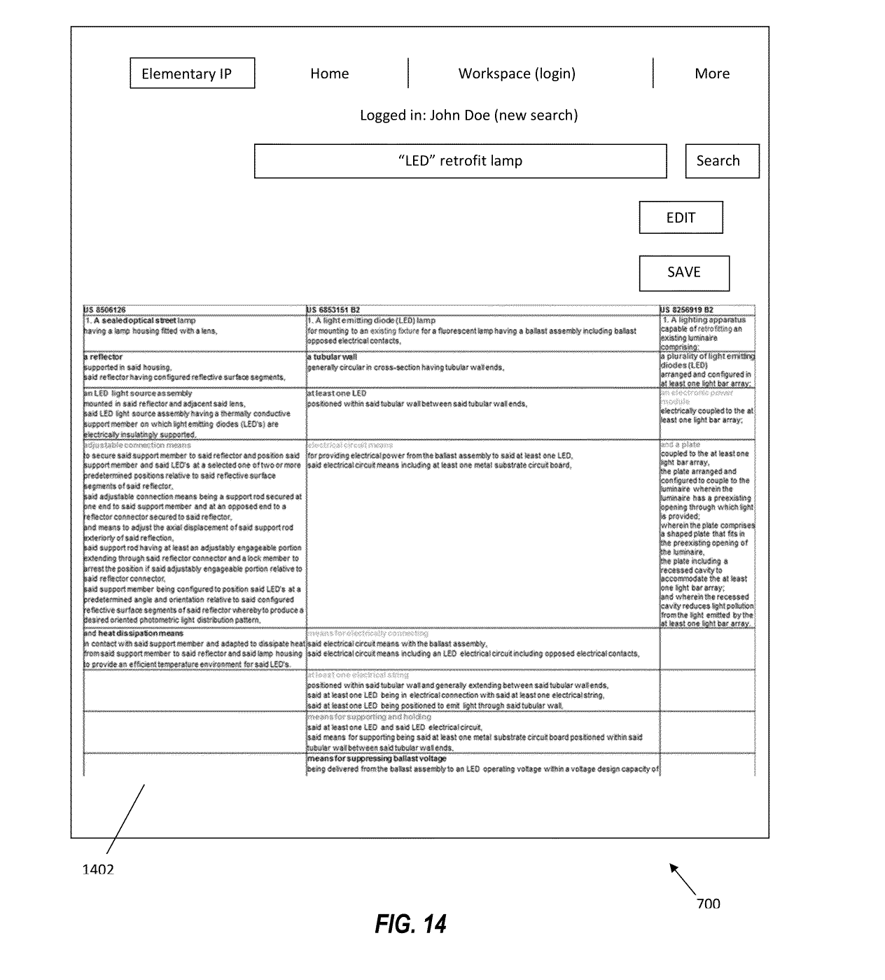

FIG. 14 show a user interface displaying a “claims worksheet” comparing the first independent claim of multiple patents, with color coded claim segments, in accordance with an embodiment of the present invention. The claims worksheet can be used as a draft for the Patent Claim Chart that is typically used by IP attorneys to compare a given patent to similar patents, typically in patent litigation, assertion, or licensing. The user interface 700 shows a table 1402 that shows the mapping of claim elements of a specific patent with the independent claims of the most relevant patents provided by the semantic search engine. This display method can be extended to map segmented claims of a given patent against Product Data sheets and other Non-Patent Literature. The display comprises a table mapping the segmented claims of one patent to segmented claims of one or more other patents, with all or part of the tag contents including dictionaries displayed adjacent to corresponding tags and segments.

The search results and claims worksheet can be edited, saved or printed in user selectable formats by authorized users (for example in a secure system), and shared with select users.

The search engine and method of the present invention provides specific advantages over the existing search engines. The users can edit and annotate tags, choose colors (color, font size, other markers), and annotate any text or drawing with comments. The user can save, retrieve, share annotations with select other users. Algorithm for merging multi-user annotations (majority rule, ignore common words if conflict) can be provided. User can search for similar patents—by default claim elements are used in search query, user. Dictionaries for tags is provided—user sees dictionary of tag by clicking on it, and can browse, edit, add, share dictionaries of tags, and use or remove them in a search query. Figures for tags is provided—user sees corresponding figure by clicking on tag, figure shows tag keywords highlighted in labels in matching colors (as a legend or overlaid on figure). Image processing based methods including OCR to identify figure number and labeled invention components, NLP to associate figure number with labeled invention components is provided. Specification quotes for tags—user sees quotes from specification that includes selected tag, user can edit tag's dictionary by selecting, deselecting, annotating quotes is provided. Natural Language processing to find best quote (e.g. sentence/paragraph that contains most # tag keywords) is provided.

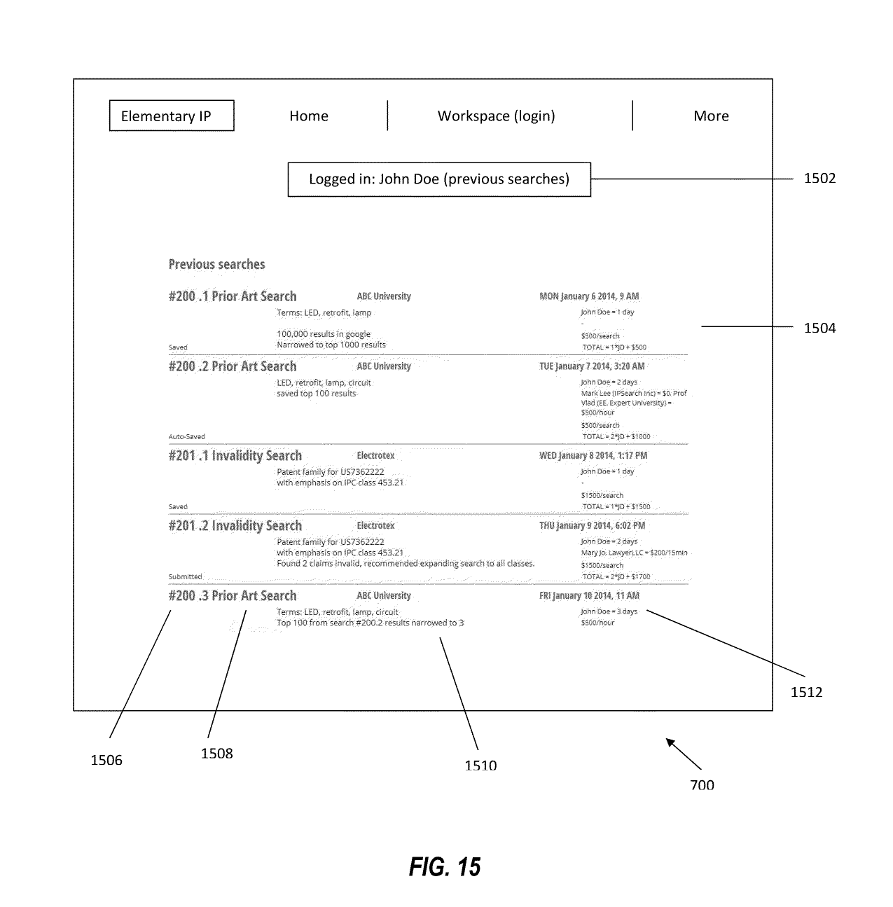

In another embodiment of the present invention, the search platform stores the metadata associated with a user's search session and history, and provides the user with a view/edit interface to the metadata. The user can store all data related to one search under a selected title. The search history begins with the first search query in the first search session and ends with the final search results and/or documents being delivered to the customer in the final search session. The search engine stores the search strings and metadata associated with each search session. The user may perform a number of operations such as search, view, edit, and save, on a number of documents such as patents, patent applications, image file wrappers, patent tags, uploaded external publications—all of which is recorded along with time stamps. The stored data can subsequently be retrieved by the user in a later session. This feature enables review of organizational workflow statistics for operational efficiencies and functions such as performance evaluation, billing, tool performance, etc. The platform also allows selective sharing of workflow with users in the same or external organizations. FIG. 15 shows a user interface displaying the search history and user metadata saved for retrieval and sharing, in accordance with an embodiment of the present invention. The user interface 700 shows a block 1502 where the user is shown as logged-in and reviewing their search history (previous searches). Portion 1504 of the user interface 700 shows the search history. Section 1506 shows the user code and the session ID, section 1508 shows the type of search performed by the user, section 1510 shows the client details and the terms used for search and the section 1512 displays the time stamp of the search performed. The user interface can be used to monetize the bills based on the working hours.

The foregoing merely illustrates the principles of the present invention. Other variations to the disclosed embodiments can be understood and effected by those skilled in the art in practicing the claimed invention from a study of the drawings, the disclosure, and the appended claims. In the claims, the word “comprising” does not exclude other elements or steps and the indefinite article “a” or “an” does not exclude a plurality. The mere fact that certain measures are recited in mutually different dependent claims does not indicate that a combination of these measures cannot be used advantageously. Any reference signs in the claims should not be construed as limiting the scope of the claims. Various modifications and alterations to the described embodiments will be apparent to those skilled in the art in view of the teachings herein. It will thus be appreciated that those skilled in the art will be able to devise numerous techniques which, although not explicitly described herein, embody the principles of the present invention and are thus within the spirit and scope of the present invention. All references cited herein are incorporated herein by reference in their entireties.

1. A method for semantic segmentation and tagging of a patent claim, the method comprising:
using natural language processing algorithms to semantically analyze and segment the claim into a plurality of tagged segments;
providing a user interface for viewing the natural language processing based segments and tags;
modifying or editing the natural language processing based segments and tags into user preference based segments and tags;
saving the edited segments and tags for subsequent retrieval by a computer system or users.

2. The method of claim 1, wherein the tagged segments are each structurally comprised of one or more of: segment boundaries in the original claim, segment content including text, tag label, and tag content including text, images and additional links or reference or metadata.

3. The method of claim 2 wherein the tag labels comprise one or more of claim preamble, claim elements, claim sub-elements, preamble attributes, element attributes, sub-element attributes, and relationships between preamble, elements, and sub-elements.

4. The method of claim 2 wherein the tag labels comprise economic value and or inventiveness of one or more of: patent, claims, elements, sub-elements, attributes, and relationships between elements and sub-elements.

5. The method of claim 2 wherein the tag contents comprise a dictionary or lookup table, with each tag's dictionary being comprised of terms similar in meaning or connotation to the segment content, from one or more of taxonomies, ontologies, bibliographies, indices, tables of content, summaries and descriptions of databases comprising language and grammar dictionaries and thesauruses, synonyms, homonyms, hypernyms, hyponyms, patent classes, library records, academic publications, scientific and technical publications, professional and business publications, and web glossaries.

6. The method of claim 2 wherein the tag contents comprise a dictionary or lookup table, with each tag's dictionary being comprised of terms similar in meaning or connotation to the segment content, from fields in the patent being tagged, or from fields in other patents, the fields comprising title, abstract, claims, background, field of invention, summary of invention, description of figures, description of embodiments, specification, images, figures, drawings, tables, and references.

7. The method of claim 2 wherein the tag contents comprise a dictionary or lookup table, with each tag's lookup table being comprised of links or references related to the segment content, from fields in the patent being tagged, or from fields in other patents, the fields comprising title, abstract, claims, background, field of invention, summary of invention, description of figures, description of embodiments, specification, images, figures, drawings, tables, and references.

8. The method of claim 1 wherein natural processing algorithms perform segmentation and tagging by using standard, grammatically-defined noun phrases and preposition phrases, or their respective modifications based on patent-specific language.

9. A method for searching for patents using semantic segmentation based tags, the method comprising:
semantically segmenting and tagging patents with a plurality of tags comprising one or more of claim preamble, claim elements, claim sub-elements, preamble attributes, element attributes, sub-element attributes, relationships between preamble, elements, and sub-elements, economic value of patent, claims, or elements, and inventiveness of patent, claims or elements;
adding tags and segments to fields searchable by means of a search query in the patent search engine;
using tags and segments in ranking and scoring of search results by the patent search engine.

10. The method of claim 9 wherein the tags comprise a dictionary, each tag's dictionary being comprised of terms similar in meaning or connotation to the tag's segment, from one or more of taxonomies, ontologies, bibliographies, indices, tables of content, summaries and descriptions of databases comprising language and grammar dictionaries and thesauruses, synonyms, homonyms, hypernyms, hyponyms, patent classes, library records, academic publications, scientific and technical publications, professional and business publications, web glossaries, and from fields in the patent being tagged, or from fields in other patents, the fields comprising title, abstract, claims, background, field of invention, summary of invention, description of figures, description of embodiments, specification, images, figures, drawings, tables, and references.

11. The method of claim 9 wherein patents with the search query found in their semantic segments and or tags are ranked or scored higher in search results than patents with the search query found in other fields, the search query being the original user entered search query or an expanded query.

12. The method of claim 10 wherein the user can construct the search query using one or more of: keywords, phrases, pseudo-claims, segments, tags, tag dictionaries, tags and segments viewed by means of a user interface, and tags and segments edited by means of a user interface.

13. A method for display, user interface and analysis of patents using semantic segmentation based tags, the method comprising:
providing semantically segmented patents tagged with a plurality of tags comprising one or more of claim preamble, claim elements, claim sub-elements, preamble attributes, element attributes, sub-element attributes, relationships between preamble, elements, and sub-elements, economic value of patent, claims or elements, and inventiveness of patent, claims or elements;
displaying tags and segments in a visually appealing manner including text and figures that is easy to comprehend;
editing tags and segments based on user preference, with ability to store the edited tags for subsequent retrieval and or sharing with other users.

14. The method of claim 13 wherein the tags comprise a dictionary, each tag's dictionary being comprised of terms similar in meaning or connotation to the tag's segment, or of links or references related to the segment, from fields in the patent being tagged, or from fields in other patents, the fields comprising title, abstract, claims, background, field of invention, summary of invention, description of figures, description of embodiments, specification, images, figures, drawings, tables, and references, and one or more of taxonomies, ontologies, bibliographies, indices, tables of content, summaries and descriptions of databases comprising language and grammar dictionaries and thesauruses, synonyms, homonyms, hypernyms, hyponyms, patent classes, library records, academic publications, scientific and technical publications, professional and business publications, and web glossaries.

15. The method of claim 13 wherein different tags are displayed to the user in different formats to accelerate comprehension, the formats being user selectable and comprising one or more of font colors, font types, font sizes, indentations, 3-D effects such as raised or lowered fonts, and animation effects.

16. The method of claim 13 wherein the tags are displayed in different aspects with respect to the patent being tagged, the aspects comprising one or more of overlay, partial overlay, translucent overlay, movable overlay, sidebar, footnote, separate screen, separate display, extended display, and full or partial 3D display.

17. The method of claim 14 wherein the user can choose to view, edit, annotate, or save the segments or tags, including the tag dictionaries, or share them with other users.

18. The method of claim 17 wherein the user can choose to search patent databases with search queries constructed from all or part of the viewed, edited, annotated, saved or shared segments and tags.

19. The method of claim 14 wherein the display comprises a table mapping the segmented claims of one patent to segmented claims of one or more other patents, with all or part of the tag contents including dictionaries displayed adjacent to corresponding tags and segments.

20. The method of claim 13 wherein the tags and or segments are selectively displayed, saved or shared based on one or more of user identity, application type, document state, user state, or other metrics.
